(19) United States
(12) Patent Application Publication
(10) Pub. No.: US 2013/0022142 A1
(43) Pub. Date: Jan. 24, 2013

(54) BASE STATION AND METHOD FOR IMPLEMENTING AN ADAPTIVE CLOSED-LOOP MIMO AND OPEN-LOOP MIMO TECHNIQUE IN A WIRELESS COMMUNICATION SYSTEM

(71) Applicant: Sairamesh Nammi, Stockholm (SE)

(72) Inventor: Sairamesh Nammi, Stockholm (SE)

(21) Appl. No.: 13/186,605

(22) Filed: Jul. 20, 2011

(51) Int. Cl. H04L 27/28

(52) U.S. Cl. 375/267

(57) ABSTRACT

A base station and a method are described herein that implement an adaptive closed-loop MIMO and open-loop MIMO technique which accounts for all channel conditions and improves the performance of communications with a user equipment. In one example, the base station and method analyze a current user equipment report and a previous user equipment report received from a user equipment to determine if at least one channel condition parameter has a rate of change greater than a corresponding at least one threshold and if yes then use an open-loop MIMO technique and if no then use a closed-loop MIMO technique when interacting with the user equipment.

### TECHNICAL FIELD

The present invention relates to a base station and a method for implementing an adaptive closed-loop MIMO and open-loop MIMO technique which accounts for all channel conditions and improves the performance of communications with a user equipment.

### BACKGROUND

The following abbreviations are herewith defined, at least some of which are referred to within the following description about at least the prior art and/or the present invention.
3GPP2 Third Generation Partnership Project 2
AWGN Additive White Gaussian Noise
BS Base Station
CDD Cyclic Delay Diversity
CQI Channel Quality Information
EESM Effective Exponential SINR Mapping
eNB Evolved Node B (Base Station)
FSS Frequency Selective Scheduling
HARQ Hybrid Automatic Repeat Request
Hz Hertz
IR Incremental Redundancy
LTE Long-Term Evolution
Mbps Megabits Per Second
MCS Modulation and Coding Scheme
MIMO Multiple-Input Multiple-Output
MMSE Minimum Mean Square Error
MRC Maximum Ratio Combining
OFDM Orthogonal Frequency-Division Multiplexing
PER Packet Error Rate
PMI Pre-Encoding Matrix Indicator
RB Resource Block
RBG Resource Block Group
RI Rank Information
SFBC-SM Space-Frequency Block Coding-Spatial Multiplexing
SINR Signal-to-Interference Ratio
SM Spatial Multiplexing
TD-SCDMA Time Division Synchronous Code-Division Multiple Access
TTI Transmit Time Interval
UE User Equipment
WB Wideband

MIMO is a promising technique for achieving high-speed data rates in a wireless communication system. Multiple streams can be transmitted between a base station and a user equipment using MIMO, thereby increasing throughput in the wireless communication system. To enable MIMO, the base station and user equipment each have multiple antennas such that multiple streams can be transmitted there between. In addition, MIMO utilizes a transmission technique known as spatial multiplexing to transmit independent and separately encoded data signals, so-called streams, from each of the multiple transmit antennas. Therefore, the space dimension is reused, or multiplexed, more than one time. For example, if the base station (e.g., transmitter) is equipped with Nₜ antennas and the user equipment (e.g., receiver) has Nᵣ antennas, then the maximum spatial multiplexing order (the number of streams) that can be transmitted between the base station and user equipment is:

Nₐ=min(Nₜₛ Nₚ) (1)

If a linear user equipment is used then Nₛ streams can be transmitted in parallel, ideally leading to an Nₛ increase of the spectral efficiency (the number of bits per second and per Hz that can be transmitted over the wireless channel). In particular, by transmitting independent symbol streams in the same frequency bandwidth using spatial multiplexing effectively enables a linear increase in data rates between the base station and user equipment by increasing the number of antennas. Plus, by using, space-time codes at the base station, reliability of the detected symbols can be improved by exploiting the so called transmit diversity. Both these schemes assume no channel knowledge at the base station. However, in practical wireless systems such as the 3GPP, LTE and WiMAX systems, the channel knowledge can be made available at the base station via feedback from the user equipment. The base station can then utilize this channel information to improve the system performance.

The base station currently uses either a closed-loop MIMO technique or an open-loop MIMO technique for transmitting downlink transmissions to the user equipment. However, the inventors have learned that neither the closed-loop MIMO technique nor the open-loop MIMO technique when used alone is suitable for all channel conditions. Accordingly, there is and has been a need for a MIMO technique which is suitable for all channel conditions. This need and other needs are addressed by the present invention.

### SUMMARY

A base station, a method, and a wireless communication system that address the aforementioned shortcoming by implementing an adaptive closed-loop MIMO and open-loop MIMO technique are described in the independent claims of the present application. Advantageous embodiments of the base station, the method, and the wireless communication system have been described in the dependent claims of the present application.

In one aspect, the present invention provides a base station which has multiple antennas and also implements an adaptive closed-loop MIMO and open-loop MIMO technique. The base station comprises a receiver that receives user equipment reports over a period of time from a user equipment, a processor, a memory that stores processor-executable instructions therein, and a transmitter. The processor interfaces with the memory and executes the processor-executable instructions to enable the following: (i) analyze a current user equipment report and a previous user equipment report received from the user equipment to determine if at least one channel condition parameter has a rate of change greater than a corresponding at least one threshold and if yes then use the open-loop MIMO technique when interacting with the user equipment and if no then use the closed-loop MIMO technique when interacting with the user equipment. The transmitter sends a message to the user equipment indicating whether currently utilizing the open-loop MIMO technique or the closed-loop MIMO technique to interact with the user equipment. The advantage of the base station implementing the adaptive closed-loop MIMO and open-loop MIMO technique is that it is suitable for all channel conditions and improves the performance of communication with the user equipment.

In yet another aspect, the present invention provides a method in a base station which has multiple antennas for implementing an adaptive closed-loop MIMO and open-loop MIMO technique. The method comprising the steps of: (a) receiving user equipment reports over a period of time from a user equipment; (b) analyzing a current user equipment report and a previous user equipment report received from the user equipment to determine if at least one channel condition parameter has a rate of change greater than a corresponding at least one threshold and if yes then use the open-loop MIMO technique when interacting with the user equipment and if no then use the closed-loop MIMO technique when interacting with the user equipment; and (c) sending a message to the user equipment indicating whether currently utilizing the open-loop MIMO technique or the closed-loop MIMO technique to interact with the user equipment. The advantage of the base station implementing the adaptive closed-loop MIMO and open-loop MIMO technique is that it is suitable for all channel conditions and improves the performance of communication with the user equipment.

In still yet another aspect, the present invention provides a wireless communication system comprising a user equipment that sends user equipment reports over a period of time and a base station which has multiple antennas and also implements an adaptive closed-loop MIMO and open-loop MIMO technique. The base station comprises a receiver that receives the user equipment reports from the user equipment, a processor, a memory that stores processor-executable instructions therein, and a transmitter. The processor interfaces with the memory and executes the processor-executable instructions to enable the following: (i) analyze a current user equipment report and a previous user equipment report received from the user equipment to determine if at least one channel condition parameter has a rate of change greater than a corresponding at least one threshold and if yes then use the open-loop MIMO technique when interacting with the user equipment and if no then use the closed-loop MIMO technique when interacting with the user equipment. The transmitter sends a message to the user equipment indicating whether currently utilizing the open-loop MIMO technique or the closed-loop MIMO technique to interact with the user equipment. The advantage of the base station implementing the adaptive closed-loop MIMO and open-loop MIMO technique is that it is suitable for all channel conditions and improves the performance of communication with the user equipment.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings:

FIGS. 1A-1C (PRIOR ART) are several drawings which are used to explain one way that a base station and user equipment can implement a closed-loop MIMO technique;

FIGS. 2A-2B (PRIOR ART) are several drawings which are used to explain one way that a base station and user equipment can implement the open-loop MIMO technique;

FIG. 3 is a block diagram of an exemplary wireless communication system which includes an enhanced base station and an user equipment in accordance with an embodiment of the present invention;

FIG. 4 is a flowchart of illustrating the basic steps of an exemplary method in the enhanced base station shown in FIG. 3 for implementing an adaptive closed-loop MIMO and open-loop MIMO technique in accordance with an embodiment of the present invention; and

FIGS. 5A-5C are several drawings which are used to explain the simulation methodology and simulation results which were used develop the enhanced base station and the adaptive closed-loop MIMO and open-loop MIMO technique in accordance with an embodiment of the present invention.

### DETAILED DESCRIPTION

The inventor in developing the present invention studied 3GPP LTE and LTE-Advanced systems which propose different MIMO modes for downlink transmission from the base station to the user equipment. In particular, the inventor studied the performance of these MIMO modes which include the closed-loop MIMO technique and the open-loop MIMO technique by using system level simulations which are discussed in detail later in this document. A brief summary of the inventor's conclusions are provided here as follows:

1. Significant gains can be achieved for slow speed channels by using closed-loop MIMO with best bands, per band PMI and CQI.

2. For high speed channels, open-loop MIMO techniques (wideband based MIMO techniques) outperform closed loop MIMO techniques due to the outdated channel state information.

3. None of the MIMO modes alone is suitable for all channel conditions.

Since, the inventor learned that none of the MIMO modes when taken alone is suitable for all channel conditions, he has developed an adaptive closed-loop MIMO and open-loop MIMO technique which is suitable for all channel conditions and improves the performance of communications between the base station and user equipment. The enhanced base station and method of the present invention can implement the adaptive closed-loop MIMO and open-loop MIMO technique by analyzing a current user equipment report and a previous user equipment report received from the user equipment to determine if one or more channel condition parameters have a rate of change that is greater than a corresponding one or more thresholds and if yes then use an open-loop MIMO technique and if no then use a closed-loop MIMO technique when interacting with the user equipment. A detailed discussion about how the enhanced base station and method can transition between the closed-loop MIMO technique and the open-loop MIMO technique is provided below after a brief discussion is provided to describe some of the basic features of both the closed loop MIMO technique and the open-loop MIMO technique.

### Closed-Loop MIMO Technique

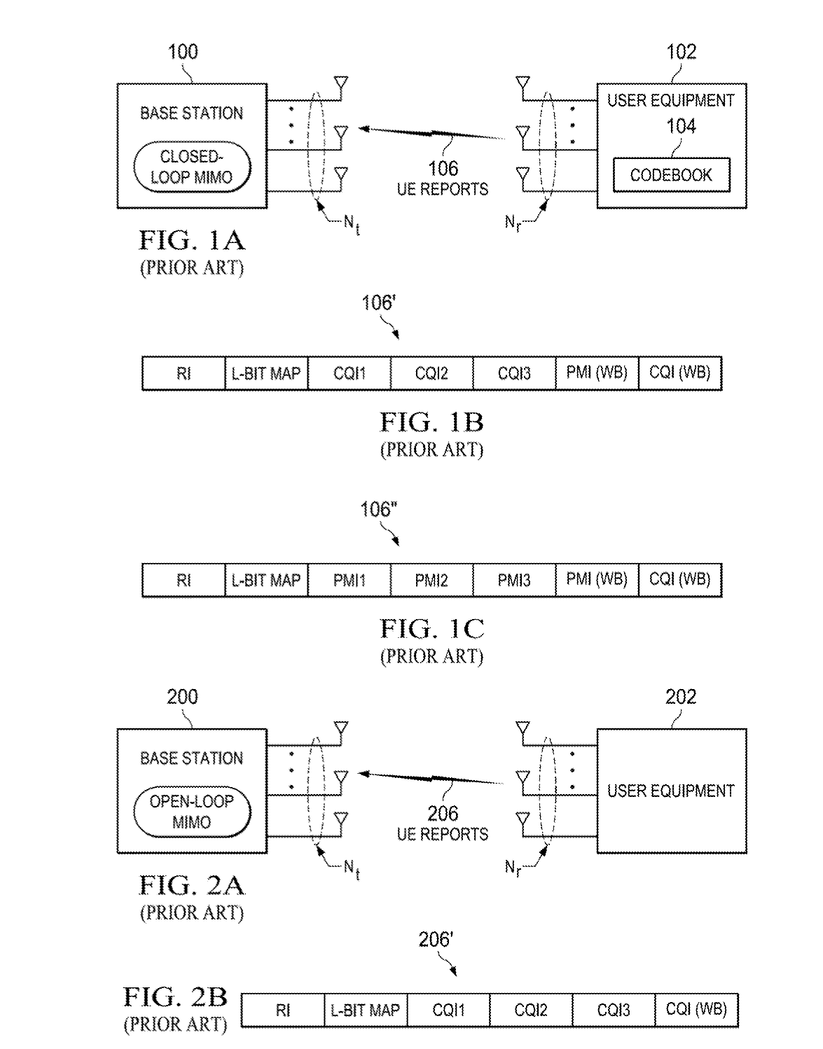

Referring to FIGS. 1A-1C (PRIOR ART), there are several drawings which are used to explain one way that the base station 100 and user equipment 102 can implement the closed-loop MIMO technique. The skilled person will appreciate that there are different forms of closed-loop MIMO and they will also appreciate that 3GPP LTE proposes closed-loop MIMO using code book based precoding. Since, the 3GPP LTE system was simulated to help develop the present invention the description herein involves the closed-loop MIMO technique which uses the code book based precoding. However, the present invention is not limited to using the closed-loop MIMO technique with code book based precoding but could use other types of closed-loop MIMO techniques.

As shown in FIG. 1A (PRIOR ART), the base station 100 (e.g., transmitter) is equipped with Nₜ antennas and the user equipment (e.g., receiver) has Nᵣ antennas such that the maximum spatial multiplexing order (the number of streams) that can be transmitted between them is Nₛ=min (Nₜ, Nᵣ). The base station 100 and user equipment 102 has an input-output relationship with the closed-loop MIMO technique which could be described as:

y=HWs+n (2)

where δ=[δ₁, δ₂, . . . . , δ_{N}_{ₑ}]^{T} is the Nₐ×1 vector of transmitted symbols, y, u are the Nₚ×1 vectors of received symbols and noise respectively, H is the Nₚ×Nₑmatrix of channel coefficients and W is the Nₑ×Nₐ linear precoding matrix. The precoding matrix W is used to precode the symbols in the vector to enhance the performance. The column dimension Nₛ of W can be selected smaller than Nₜ which is useful if the system requires Nₛ(≠Nₜ) streams because, for instance, either the rank of the MIMO channel or the number of receiver antennas is smaller than the number of transmit antennas.

The closed-loop MIMO technique which uses code book based precoding allows the user equipment 102 (receiver 102) to explicitly identify a precoding matrix/vector based on a codebook 104 that should have been used for transmission. In the 3GPP LTE standard, separate codebooks 104 are defined for various combinations of the number of transmit antennas and the number of transmission layers. The transmission layers are referred to herein as rank information (RI). For example, TABLE 1 shows the precoding vectors and matrices in the codebook 104 for the scenarios of RI=1 and RI=2, respectively, assuming two transmit antennas are employed at the base station 100 (e.g., eNB 100). The 3GPP LTE standard does not specify what criteria that the user equipment 102 should use to compute the RI and/or the optimum precoding matrices/vectors.

TABLE 1

| Codebook | R1 | |
|---|---|---|
| index | 1 | 2 |
| 0 | — | — |
| 1 | — | $\frac{1}{2} [ \begin{matrix}1 & 1 \\ 1 & - 1\end{matrix} ]$ |
| 2 | $\frac{1}{\sqrt{2}} [ \begin{matrix}1 \\ 1\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - 1\end{matrix} ]$ | — |
| 4 | $\frac{1}{\sqrt{2}} [ \begin{matrix}1 \\ j\end{matrix} ]$ | — |
| 5 | $\frac{1}{\sqrt{2}} [ \begin{matrix}1 \\ - j\end{matrix} ]$ | — |

Typically in a closed-loop MIMO system, the user equipment 102 periodically sends UE reports 106 to the base station 100. The UE report 106 generally includes a RI, a L-bit map indicating the best sub band locations in the whole OFDM band and their corresponding CQI's or PMI's, wideband PMI and wideband CQI. FIG. 1B shows a typical UE CQI report 106′ using frequency selected CQI for a 10 MHz LTE system (3 best sub-bands). FIG. 1C shows a typical UE report 106″ using frequency selective PMI.

### Open-Loop MIMO Technique

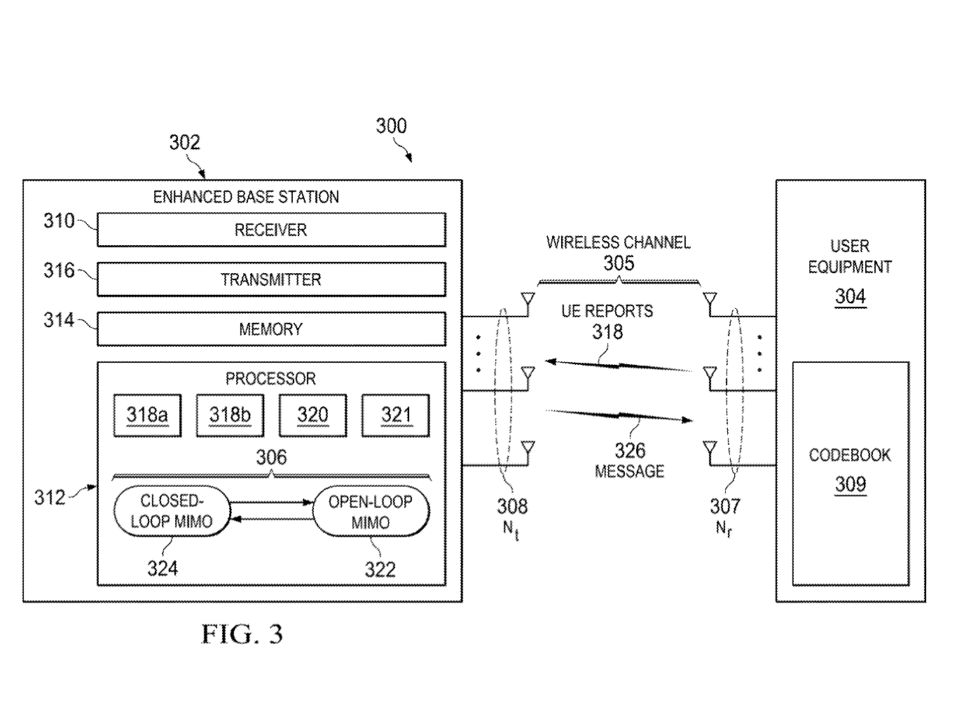

Referring to FIGS. 2A-2B (PRIOR ART), there are several drawings which are used to explain one way that the base station 200 and user equipment 202 can implement the open-loop MIMO technique. In this example, the base station 200 (e.g.; transmitter) is equipped with Nₜ antennas and the user equipment (e.g., receiver) has Nᵣ antennas such that the maximum spatial multiplexing order (the number of streams) that can be transmitted between them is Nₛ=min (Nₜ, Nᵣ). The base station 200 and user equipment 202 has an input-output relationship with the open-loop MIMO technique which could be described as:

y=Hx+n (3)

where x =[x₁, x₂, . . . . , x_{N}_{ₜ}]^{T} is the Nₜ×1 vector of transmitted symbols, y, n are the Nₚ×1 vectors of received symbols and noise respectively and H is the N_{T}×Nₜ matrix of channel coefficients. The open-loop MIMO technique does not require any precoding since it is basically an adaptation between transmit diversity and spatial multiplexing. Typically in a open-loop MIMO system, the user equipment 202 sends UE reports 206 to the base station 100. The UE report 206 generally includes a RI, a L-bit map indicating best sub band locations in the whole OFDM band and their corresponding CQI's, and wideband CQI. FIG. 2B shows a typical UE CQI report 206′ using frequency selected CQI for a 10 MHz LTE system (3 best sub-bands).

### Adaptive Closed-Loop MIMO and Open-Loop MIMO

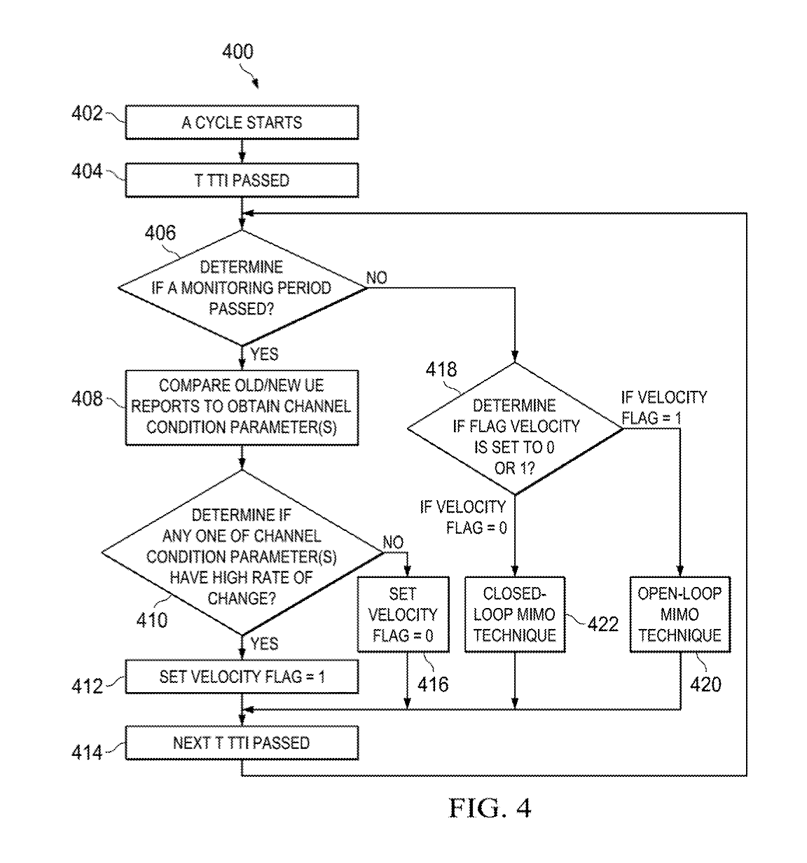

Referring to FIG. 3, there is a block diagram of an exemplary wireless communication system 300 which includes an enhanced base station 302 (one shown) and an user equipment 304 (one shown) in accordance with an embodiment of the present invention. The enhanced base station 302 (e.g., enhanced eNB 302) is configured to implement an adaptive closed-loop MIMO and an open-loop MIMO technique 306 technique which accounts for all channel conditions and improves the performance of communications with the user equipment 304. The term channel conditions refers to one or more conditions of a wireless channel 305 between the enhanced base station 302 and the user equipment 304 (discussed below). The user equipment 304 has multiple antennas 307 (Nᵣ) and a precoding codebook 309.

The enhanced base station 302 includes multiple antennas 308 (NO, a receiver 310, a processor 312, a memory 314, and a transmitter 316. The receiver 310 is configured to receive UE reports 318 over a period of time from the user equipment 304. The receiver 310 is coupled to the multiple antennas 308 and the processor 312. The processor 312 is configured to interface with the memory 314 and execute processor-executable instructions stored therein to analyze a current user equipment report 318a and a previous user equipment report 318b (or multiple previous user equipment reports 318b) received from the user equipment 304 to determine if one or more channel condition parameters 320 has a rate of change greater than a corresponding one or more thresholds 321 and if yes then use the open-loop MIMO technique 322 when interacting with the user equipment 304 and if no then use the closed-loop MIMO technique 324 when interacting with the user equipment 304. The processor 312 is coupled to the transmitter 316. The transmitter 316 is configured to send a message 326 to the user equipment 304 indicating whether the open-loop MIMO technique 322 or the closed-loop MIMO technique 324 is currently being used to interact with the user equipment 304. The user equipment 304 upon the receipt of message 326 knows whether to use the open-loop MIMO technique 322 or the closed-loop MIMO technique 324 to interact with the enhanced base station 302.

The channel condition parameters 320 that can be monitored and used to determine when to implement a state transition between the open-loop MIMO technique 322 and the closed-loop MIMO technique 324 can be as follows (for example):

1. User Equipment Speed.

2. Frequency Locations.

3. Channel Quality Information (CQI).

4. PMI.

To help monitor the channel condition parameters 320, the enhance based station IS 302 uses the received UE reports 318 from the user equipment 304. For example, the received UE report 318 can include a RI, a L-bit map indicating the best sub band locations in the whole OFDM band and their corresponding CQI's or PMI's, wideband PMI and wideband CQI when the UE 304 is using the closed-loop MIMO technique 324 (see e.g., FIGS. 1B and 1C). Furthermore, the received UE report 318 can include a RI, a L-bit map indicating best sub band locations in the whole OFDM band and their corresponding CQI's, and wideband CQI when the UE 304 is using the open-loop MIMO technique 322 (see e.g., FIG. 2B).

The criteria that the enhanced base station 302 can use for determining when to implement the state transition between the open-loop MIMO technique 322 and the closed-loop MIMO 324 can be as follows (for example):

1. Speed Savg (average over k TTI) of user equipment 304
If Savg>Threshold_speed Km/hr 321 then transition to the open-loop MIMO technique 322.

2. Frequency Location change rate (over k TTI)
If ΔF/Δt>Threshold_adaptation 321 then transition to the open-loop MIMO technique 322.

3. Rate of Change of CQI (over k TTI)
If ΔCQ/Δt>Threshold_CQI 321 then transition to the open-loop MIMO technique 322.

4. Rate of Change of PMI (over k TTI)
If ΔPMI>Threshold_PMI 321 then transition to the open-loop MIMO technique 322.

The skilled person will appreciate that the exemplary wireless communication system 300, the enhanced base station 302, and the user equipment 304 all include many other components which are well known to those skilled in the art but for clarity are not described herein while the components of the enhanced base station 302 and the user equipment 304 which are relevant to the present invention have been described in detail herein. In addition, the skilled person will appreciate that the present invention can be used in any type of wireless communication system such as for example a 3GPP, LTE or WiMAX system that utilizes a MIMO technique.

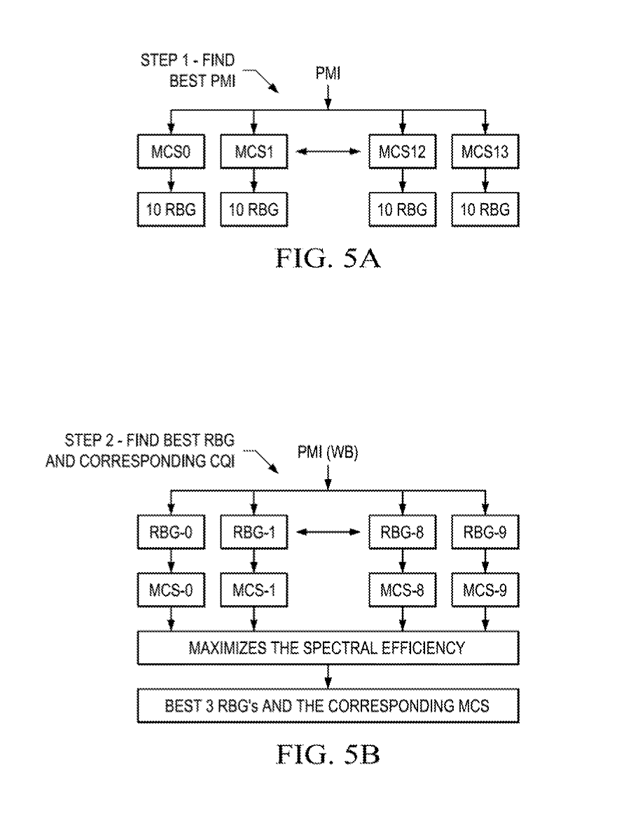

Referring to FIG. 4, there is a flowchart of illustrating the basic steps of an exemplary method 400 in the enhance base station 302 for implementing the adaptive closed-loop MIMO and open-loop MIMO technique 306 in accordance with an embodiment of the present invention. Beginning at steps 402 and 404, the enhanced base station 302 starts a cycle and waits for a TTI (e.g., 5 ms) to pass. At step 406, the enhanced base station 302 determines if a monitoring period passed, where the monitoring period has a duration corresponding to a predetermined number of TTIs. For example, the monitoring period can be represented as mod (T, T_mon)==0 where if the monitoring period (T_mon) is set at 100 TTIs then after each time 100 TTIs have passed step 418 is performed otherwise step 408 is performed. In this example, step 408 is performed 99 times and step 418 is performed 1 time for each 100 TTI monitoring period.

If the result of the determine step 406 is yes, then the enhanced base station 302 compares at step 408 the current UE report 318a and the previous UE report 318b (or multiple previous UE reports 318b) to obtain one or more channel condition parameters 320. For example, the channel condition parameters 320 can include at least one of user equipment speed, frequency locations, CQI, and PMI. At step 410, the enhanced base station 302 then determines if anyone of the channel condition parameters 320 has a rate of change greater than a corresponding one or more thresholds 321. For example, the enhanced base station 302 can check if at least one of the following is true: Savg>Threshold_speed, ΔF/Δt>Threshold adaptation, ΔCQ/Δt>Threshold_CQI, and ΔPMI>Threshold_PMI. If the result of the determine step 410 is yes, then the enhanced base station 302 at step 412 sets a mobile velocity flag to a first value (e.g., “1”), waits at step 414 for the next TTI to pass, and then returns to the first determine step 406. If the result of the determine step 410 is no, then the enhanced base station 302 at step 416 sets the mobile velocity flag to a second value (e.g., “0”), waits at step 414 for the next TTI to pass, and then returns back to the first determine step 406.

If the result of the determine step 406 is no, then the enhanced base station 302 at step 418 determines if the mobile velocity flag is set to either the first value (e.g., “1”) or the second value (e.g., “0”). If the mobile velocity flag is set to the first value (e.g., “1”), then the enhanced base station 302 at step 420 uses the open-loop MIMO technique 322, waits at step 414 for the next TTI to pass, and then returns to the first determine step 406. If the mobile velocity flag is set to the second value (e.g., “0”), then the enhanced base station 302 uses at step 422 the closed-loop MIMO technique 324, waits at step 414 for the next TTI to pass, and then returns to the first determine step 406. The enhanced base station 302 also send a message 326 to the user equipment 304 indicating whether the open-loop MIMO technique 322 or the closed-loop MIMO technique 324 is currently being used to interact with the user equipment 304.

### System Level Simulations

The inventor in developing the invention simulated 3GPP LTE and LTE-Advanced systems which propose different MIMO modes for downlink transmission from the base station to the user equipment. The following discussion about the simulation performed by the inventor has these topics: (I) simulation methodology; (II) overview of closed-loop MIMO; (III) overview of open-loop MIMO (SFBC-SM—CDD) ; (IV) simulation results; and (V) conclusions.

### I. Simulation Methodology

1. 57 sector simulation:
   UEs are dropped uniformly only in the center 2 sectors.
   Interference from surrounding 55 sectors is simulated.
2. Full queue traffic modeled.
3. Synchronous & non-adaptive HARQ transmission scheme with 3 re-transmissions (excluding first time transmission) is modeled.
4. No Handoff between the sectors.
5. No Power control used. The eNB transmits at full power on all the tones.
6. Link level AWGN curves for all MCS schemes employ an interleaver size of 2880 bits.
7. Spatial correlation at the eNB is equal to [1 0.3], and at the UE is [1 0.0925]
8. LTE system parameters set as per 3GPP evaluation methodology (see TABLES 2-3).

TABLE 2
LTE System Parameters

| Parameter | Value |
|---|---|
| Transmission Bandwidth | 10 MHz |
| Sub-Carrier Spacing | 15 KHz |
| FFT size | 1024 |
| Number of Occupied Sub-carriers | 601 (Include DC sub-carrier) |
| CP Duration (sample) | 73 for all OFDM symbols |
| TTI Duration | 1 ms |
| Number of DC Sub-Carrier | 1 |
| Number of Useful Sub-Carriers | 600 |
| Number of Symbols per RB | 14 |
| Number of Sub-carriers per RB | 12 |
| Number of Data Sub-Carriers per RB | 132 |
| Number of Pilot + Control | 36 |
| Sub-Carriers per RB | |

TABLE 3
Link Budget

| Parameter | Value |
|---|---|
| Number of cells (3 sectored) | 19 |
| BS-to-BS distance | 500 m |
| Minimum eNB and UE | 35 m |
| distance | |
| BS Transmission Power | 46 dBm |
| | (20 Watts for 5 MHz) |
| Shadowing | 8 dB |
| Base Station Shadow | 0.5 |
| Correlation | |
| Pathloss | 118.1 + 37.6*log10(d), |
| | d is in unit of km |
| Antenna Pattern | 70 degree (−3 dB) with |
| | 20 dB front-to-back ratio |
| Thermal Noise Density | −174 dBm/Hz |
| eNB Noise Figure | 5 dB |
| eNB Maximum SINR | 30 dB |
| eNB Antenna Gain | 14 dB |
| UE Antenna Gain | 0 dB |
| UE Other Loss | 10 dB |

9. Channel Models
   UEs are moving with a velocity of 3 km/h, 10 Km/h, 30 Km/h, 40 Km/h 120 Km/h
   A 6 multipath Typical Urban (TU6) channel model is used on top of the above channels in the simulation to generate frequency selective Rayleigh fading. TABLE 4 below shows the delay & power of each resolvable path.

TABLE 4
Channel Model

| Path Index | Power (dB) | Delay (us) | Fading Model |
|---|---|---|---|
| 1 | −3 | 0.0 | Jakes |
| 2 | 0 | 0.2 | Jakes |
| 3 | −2 | 0.5 | Jakes |
| 4 | −6 | 1.6 | Jakes |
| 5 | −8 | 2.3 | Jakes |
| 6 | −10 | 5.0 | Jakes |

10. SINR Calculation
   SINR per tone is calculated using MRC detector for rank(R) 1 and MMSE detector for rank-2 systems.
   Perfect channel estimation at the UE's receiver.
   SINR for the entire packet is then calculated by averaging the per tone SINR values (only over the tones used by the packet) using the Effective Exponential SINR Mapping (EESM) technique which is as follows:

$${SINR}_{eff}^{m} = - {β}_{m} ln ( \frac{1}{NR} {\sum }_{k = 1}^{N} {\sum }_{i = 1}^{Nt} {e}^{- \frac{SINR ( k )}{{β}_{m}}} )$$

βₘ=Beta value of the MCS m used by the packet,
N=Number of tones used by the packet
11. Link Adaptation
   UE computes one SINR value averaged over all tones at its receiver to the eNB. The eNB receives this information after a delay of 3 TTIs
   The eNB decides the MCS that gives <=10% PER with this SINR in the current channel conditions. The MCS used are shown in TABLE 5:

TABLE 5
MCS

| MCS Index | Modulation | Code Rate | Sp. Eff. (b/s/Hz) |
|---|---|---|---|
| 1 | QPSK | 1/12 | 0.1667 |
| 2 | QPSK | 1/6 | 0.3333 |
| 3 | QPSK | 1/3 | 0.667 |
| 4 | QPSK | 1/2 | 1.000 |
| 5 | QPSK | 2/3 | 1.333 |
| 6 | QPSK | 3/4 | 1.500 |
| 7 | 16QAM | 3/7 | 1.714 |
| 8 | 16QAM | 1/2 | 2.000 |
| 9 | 16QAM | 2/3 | 2.667 |
| 10 | 16QAM | 3/4 | 3.000 |
| 11 | 16QAM | 5/6 | 3.333 |
| 12 | 64QAM | 2/3 | 4.000 |
| 13 | 64QAM | 3/4 | 4.500 |
| 14 | 64QAM | 5/6 | 5.000 |

12. Scheduler
   For Best Effort UEs, proportional fair scheduler used. Every quantum (5 RBs in the simulation), the scheduler selects the user with the highest weight:

$$winner = arg {max}_{k} \frac{Instantaneous {rate}_{k}}{Average {rate}_{k}}$$

This winner is assigned quantum no. of RBs (i.e. 5). After each assignment, the PF weight/metric for all users is re-evaluated:

$$Average {rate}_{k} = \{ \begin{matrix}( 1 - η ) Average {rate}_{k} , & if k \neq winner \\ ( 1 - η ) Average {rate}_{k} + η Instantaneous {rate}_{k} , & if k = winner\end{matrix}$$

Steps 1, 2 (every TTI) are repeated until all the RBs in the current TTI are assigned. Localized transmission scheme is used.

### II. Overview of Closed-Loop MIMO

1. Codebook based precoding (see TABLE 6).
2. H-ARQ with full-IR is used.
3. H-ARQ transmissions use PMI based on first transmission.

TABLE 6
Codebook

| Codebook | Number of layers | |
|---|---|---|
| index | 1 | 2 |
| 0 | — | — |
| 1 | — | $\frac{1}{2} [ \begin{matrix}1 & 1 \\ 1 & - 1\end{matrix} ]$ |
| 2 | $\frac{1}{\sqrt{2}} [ \begin{matrix}1 \\ 1\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - 1\end{matrix} ]$ | — |
| 4 | $\frac{1}{\sqrt{2}} [ \begin{matrix}1 \\ j\end{matrix} ]$ | — |
| 5 | $\frac{1}{\sqrt{2}} [ \begin{matrix}1 \\ - j\end{matrix} ]$ | — |

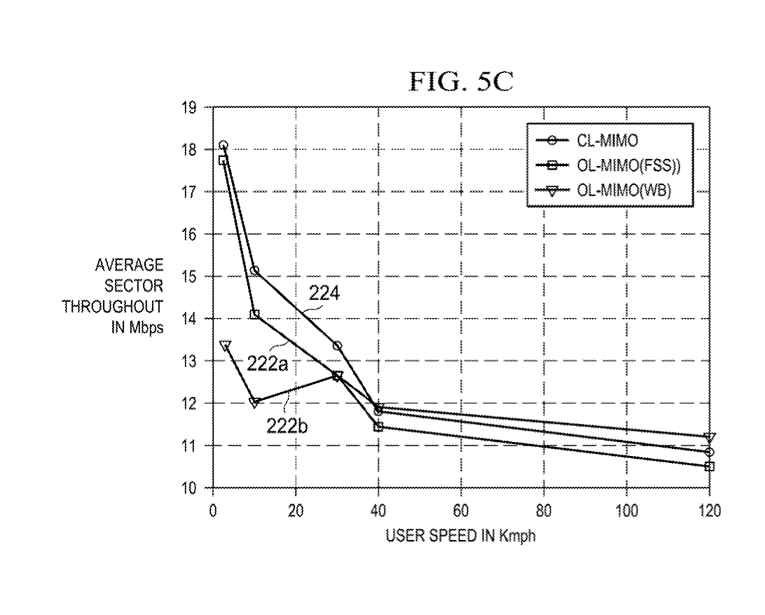

4. UE Report includes:
   Wideband RI and PMI information.
   Sub band locations are sent by a bit map.
   Sub band CQI and locations are conditioned on the wideband RI/PMI (see FIGS. 1B-1C).
5. Exhaustive Search (Brute force) method is used to select CQI/PMI & best RBGs. (Actual terminal implementation may be different)
6. The pre-coding matrix & CQI is selected based on maximizing instantaneous effective SNR at MRC/MMSE detector.
7. According to LTE Standard each RBG contains 6 RBs (used 5 in simulations).
8: Two step process:
   Step-1 Exhaustive Search (Finding the Best wideband PMI/RI)(see FIG. 5A):
      a. For each PMI spectral efficiency is found using exhaustive search.
      b. UE will choose the PMI which maximizes the spectral efficiency.
      c. If spectral efficiency of any of the two PMI/s are equal, then it chooses the PMI which maximizes the SNR and spectral efficiency.
   Step-2 Finding the best RGB and the corresponding CQI conditioned on the wideband RI/PMI (see FIG. 5B).

### III. Overview of Open-Loop MIMO (SFBC-SM—CDD)

1. Adaptation between Rank-1 and Rank-2.
2. H-ARQ with full -IR is used.
3. H-ARQ transmissions use rank based on first transmission.
4. In CDD, same signal is transmitted through each antenna with a delay specific to that antenna.
5. Equivalent to intentionally creating multipath propagation or frequency selectivity in the channel.
6. Channel code/decoder potentially exploits this frequency diversity.
7. UE Report includes:
   Wideband RI
   No PMI (see FIG. 2B)

### IV. Simulation Results

The simulation results are shown in FIG. 5C which is a graph illustrating an open-loop MIMO technique (OL-MIMO(FSS) 222a, an open-loop MIMO technique (OL-MIMO (WB) 222b, and a closed-loop MIMO technique 224 with respect to user speed in Kmph (x-axis) and average sector throughput in Mbps (y=axis). The data in this graph is represented in TABLE 7 (comparison between user equipment speed with 5 ms. TTI reporting period).

TABLE 7

| | | | | % gain of closed | |
|---|---|---|---|---|---|
| | | | | loop MIMO | |
| | Average sector throughput in Mbps | | | SFBC- | SFBC- |
| | Closed loop | SFBC-SM | SFBC-SM | SM | SM |
| UE speed | MIMO (FSS) | (WB) | (FSS) | (WB) | (FSS) |
| 3 | 18.18 | 13.43 | 17.8 | 26.13 | 2.09 |
| 10 | 15.18 | 12.05 | 14.11 | 20.62 | 7.05 |
| 30 | 13.39 | 12.66 | 12.65 | 4.81 | 4.89 |
| 40 | 11.83 | 11.91 | 11.46 | −0.68 | 3.13 |
| 120 | 10.82 | 11.21 | 10.5 | −3.6 | 2.96 |

In view of FIG. 5C, it can be observed that:
For slow speed closed loop MIMO outperforms SFBC-SM based on wideband due to FSS.
For high speed channels SFBC-SM (WB) outperforms closed loop MIMO (FSS).
Hence the speed threshold is 40 Kmph for 700 MHz (equivalent Doppler is 26 Hz).

The inventor also performed a simulation related to Sub-Band Frequency Location Rate Change. The conditions and results of this simulation are as follows:
1. The monitoring period is set to be 50 TTI and reporting period is 5 TTI
2. 0≦ΔF/Δt≦3, hence the mean of ΔF/Δt is between 0 and 3.
3. From simulations, it can be seen that the threshold is 1.4 (corresponds to 40 Kmph) as shown in TABLE 8.

TABLE 8

| | | Mean |
|---|---|---|
| Reporting | Computing | frequency |
| Period | period | rate |
| 5 | 50 | 1.42 |
| 5 | 100 | 1.47 |

Although multiple embodiments of the present invention have been illustrated in the accompanying Drawings and described in the foregoing Detailed Description, it should be understood that the invention is not limited to the disclosed embodiments, but instead is also capable of numerous rearrangements, modifications and substitutions without departing from the present invention that as has been set forth and defined within the following claims.

1. A base station which has multiple antennas and also implements an adaptive closed-loop multiple input multiple output (MIMO) and open-loop MIMO technique, the base station comprising:
a receiver that receives user equipment reports over a period of time from a user equipment;
a processor; and
a memory that stores processor-executable instructions therein where the processor interfaces with the memory and executes the processor-executable instructions to enable the following:
analyze a current user equipment report and a previous user equipment report received from the user equipment to determine if at least one channel condition parameter has a rate of change greater than a corresponding at least one threshold and if yes then use the open-loop MIMO technique when interacting with the user equipment and if no then use the closed-loop MIMO technique when interacting with the user equipment; and
a transmitter that sends a message to the user equipment indicating whether currently utilizing the open-loop MIMO technique or the closed-loop MIMO technique to interact with the user equipment.

2. The base station of claim 1, wherein the at least one channel condition parameter is an average speed of the user equipment.

3. The base station of claim 1, wherein the at least one channel condition parameter is a frequency location change rate associated with the user equipment.

4. The base station of claim 1, wherein the at least one channel condition parameter is a Channel Quality Information (CQI) change rate associated with the user equipment.

5. The base station of claim 1, wherein the at least one channel condition parameter is a Pre-Encoding Matrix Indicator (PMI) change rate associated with the user equipment.

6. The base station of claim 1, wherein the user equipment reports include one or more of following:
a rank information (RI), a L-bit map, a plurality of Channel Quality Information (CQIs), a wideband Pre-Encoding Matrix Indicator (PMI), and a wideband CQI;
a rank information (RI), a L-bit map, a plurality of PMIs, a wideband PMI, and a wideband CQI; and
a rank information (RI), a L-bit map, a plurality of CQIs, and a wideband CQI.

7. The base station of claim 1, wherein the processor executes the process-executable instructions to perform the analyze operation as follows:
start a cycle and wait for a transmit time interval (TTI) to pass;
determine if a monitoring period passed, where the monitoring period has a duration corresponding to a predetermined number of TTIs;
if result of the first determine step is yes, then:
compare the current user equipment report and the previous user equipment report to obtain the at least one channel condition parameter;
determine if the at least one channel condition parameter has a rate of change greater than the corresponding at least one threshold;
if the result of the second determine step is yes, then set a mobile velocity flag to a first value, wait for next TTI to pass, and return to the first determine step;
if the result of the second determine step is no, then set a mobile velocity flag to a second value, wait for next TTI to pass, and return to the first determine step;
if the first determine step is no, then determine if the mobile velocity flag is set to either the first value or the second value;
if the mobile velocity flag is set to the first value, then use the open-loop MIMO technique, wait for the next TTI to pass, and return to the first determine step;
if the mobile velocity flag is set to the second value, then use the closed-loop MIMO technique, wait for the next TTI to pass, and return to the first determine step.

8. A method in a base station which has multiple antennas for implementing an adaptive closed-loop multiple input multiple output (MIMO) and open-loop MIMO technique, the method comprising the steps of:
receiving user equipment reports over a period of time from a user equipment;
analyzing a current user equipment report and a previous user equipment report received from the user equipment to determine if at least one channel condition parameter has a rate of change greater than a corresponding at least one threshold and if yes then use the open-loop MIMO technique when interacting with the user equipment and if no then use the closed-loop MIMO technique when interacting with the user equipment; and
sending a message to the user equipment indicating whether currently utilizing the open-loop MIMO technique or the closed-loop MIMO technique to interact with the user equipment.

9. The method of claim 8, wherein the at least one channel condition parameter is an average speed of the user equipment.

10. The method of claim 8, wherein the at least one channel condition parameter is a frequency location change rate associated with the user equipment.

11. The method of claim 8, wherein the at least one channel condition parameter is a Channel Quality Information (CQI) change rate associated with the user equipment.

12. The method of claim 8, wherein the at least one channel condition parameter is a Pre-Encoding Matrix Indicator (PMI) change rate associated with the user equipment.

13. The method of claim 8, wherein the user equipment reports include one or more of following:
a rank information (RI), a L-bit Map, a plurality of Channel Quality Information (CQIs), a wideband Pre-Encoding Matrix Indicator (PMI), and a wideband CQI;
a rank information (RI), a L-bit map, a plurality of PMIs, a wideband PMI, and a wideband CQI; and
a rank information (RI), a L-bit map, a plurality of CQIs, and a wideband CQI.

14. The method of claim 8, wherein the analyzing step further comprises:
starting a cycle and waiting for a transmit time interval (TTI) to pass;
determining if a monitoring period passed, where the monitoring period has a duration corresponding to predetermined number of TTIs;
if result of the first determining step is yes, then:
comparing the current user equipment report and the previous user equipment report to obtain the at least one channel condition parameter;
determining if the at least one channel condition parameter has a rate of change greater than the corresponding at least one threshold;
if the result of the second determining step is yes, then setting a mobile velocity flag to a first value, waiting for next TTI to pass, and returning to the first determining step;
if the result of the second determining step is no, then setting a mobile velocity flag to a second value, waiting for next TTI to pass, and returning to the first determining step;
if the first determining step is no, then determining if the mobile velocity flag is set to either the first value or the second value;
if the mobile velocity flag is set to the first value, then using the open-loop MIMO technique, waiting for the next TTI to pass, and returning to the first determining step;
if the mobile velocity flag is set to the second value, then using the closed-loop MIMO technique, waiting for the next TTI to piss, and returning to the first determining step.

15. A wireless communication system comprising:
a user equipment that sends user equipment reports over a period of time;
base station which has multiple antennas and also implements an adaptive closed-loop multiple input multiple output (MIMO) and open-loop MIMO technique, the base station comprising:
a receiver that receives the user equipment reports from the user equipment;
a processor; and
a memory that stores processor-executable instructions therein where the processor interfaces with the memory and executes the processor-executable instructions to enable the following:
analyze a current user equipment report and a previous user equipment report received from the user equipment to determine if at least one channel condition parameter has a rate of change greater than a corresponding at least one threshold and if yes then use the open-loop MIMO technique when interacting with the user equipment and if no then use the closed-loop MIMO technique when interacting with the user equipment; and
a transmitter that sends a message to the user equipment indicating whether currently utilizing the open-loop MIMO technique or the closed-loop MIMO technique to interact with the user equipment.

16. The wireless communication system of claim 15, wherein the at least one channel condition parameter includes one or more of following:
an average speed of the user equipment;
a frequency location change rate associated with the user equipment;
a Channel Quality Information (CQI) change rate associated with the user equipment; and
a Pre-Encoding Matrix Indicator (PMI) change rat associated with the user equipment.

17. The wireless communication system of claim 15, wherein the user equipment reports include one or more of following:
a rank information (RI), a L-bit map, a plurality of Channel Quality Information (CQIs), a wideband Pre-Encoding Matrix Indicator (PMI), and a wideband CQI;
a rank information (RI), a L-bit map, a plurality of PMIs, a wideband PMI, and a wideband CQI; and
a rank information (RI), a L-bit map, a plurality of CQIs, and a wideband CQI.

18. The wireless communication system of claim 15, wherein the processor executes the process-executable instructions to perform the analyze operation as follows:
start a cycle and wait for a transmit time interval (TTI) to pass;
determine if a monitoring period passed, where the monitoring period has a duration corresponding to a predetermined number of TTIs;
if result of the first determine step is yes, then:
compare the current user equipment report and the previous user equipment report to obtain the at least one channel condition parameter;
determine if the at least one channel condition parameter has a rate of change greater than the corresponding at least one threshold;
if the result of the second determine step is yes, then set a mobile velocity flag to a first value, wait for next TTI to pass, and return to the first determine step;
if the result of the second determine step is no, then set a mobile velocity flag to a second value, wait for next TTI to pass, and return to the first determine step;
if the first determine step is no, then determine if the mobile velocity flag is set to either the first value or the second value;
if the mobile velocity flag is set to the first value, then use the open-loop MIMO technique, wait for the next TTI to pass, and return to the first determine step;
if the mobile velocity flag is set to the second value, then use the closed-loop MIMO technique, wait for the next TTI to pass, and return to the first determine step.
